(19) United States
(12) Patent Application Publication
(10) Pub. No.: US 2005/0057506 A1
(43) Pub. Date: Mar. 17, 2005

(54) Mouse structure

(76) Inventor: Chung-Ping Chi, Chung Ho City (TW)

Correspondence Address: Yi-Wen Tseng, 509 ROOSEVELT BLVD. #D306, FALLS CHURCH, VA, 22044, US

(21) Appl. No.: 10/677,313

(22) Filed: Oct. 3, 2003

(30) Foreign Application Priority Data
Aug. 29, 2003 (TW) 092215684

(51) Int. Cl. G09G 5/08

(52) U.S. Cl. 345/163

(57) ABSTRACT

An improved mouse structure, having a receiving chamber within a hand-held portion of thereof. The receiving chamber is allocated without affecting operation of interior components of the mouse. The enclosure of the mouse can be open to store or hide articles in the receiving chamber. Thereby, an additional article storage is provided by the existing mouse of the computer.

### BACKGROUND OF THE INVENTION

The present invention relates to an improved mouse structure and, more particularly, to a mouse which utilizes the unused internal space thereof as a storage device.

As shown in FIG. 1, a mouse 1a is typically used in the conventional computer system 3a for controlling various types of operations. The front part of the mouse 1a includes a set of press buttons, while the bottom of the mouse 1a includes an optical device allows the mouse 1a to control the cursor on the screen of the computer system 3a by optical principle. In addition to the mouse 1a, a controller 2a is always frequently used for controlling cursor or operations of various peripherals of the computer system 3a. As shown in FIG. 1, the controller 2a is used to control the activation of multimedia, volume, on/off status of screen and channel selection.

As the mouse 1a is the necessary device and is normally hardwired with or disposed at the same location with the computer device 3a, it is easier to properly keep the mouse 1a. In contrast, the controller 2a allows the user to control the computer system 3a remote from the computer system 3a, it is thus easily lost or mislocated.

### BRIEF SUMMARY OF THE INVENTION

The present invention provides an improved mouse structure, which converts the unused internal space thereof into a receiving chamber, such that an article such as the controller can be disposed in the receiving chamber. The controller can thus be safely kept with the mouse. The utility of the mouse is thus enhanced.

The present invention is characterized in converting the hand-held portion of the mouse as a receiving chamber to store an article which is easily lost or mislocated. The receiving chamber is formed with or without a lid, such that the article is either visible or hidden in the receiving chamber.

The article to be stored in the receiving chamber of the mouse includes a control surface and a hand-held surface opposing to the control surface. For a mouse having an open-type receiving chamber, the control surface is facing downward for being installed into the mouse, while the hand-held surface of the article is in contact with the hand of the user when the mouse is in use.

### BRIEF DESCRIPTION OF THE DRAWINGS

These, as well as other features of the present invention, will become apparent upon reference to the drawings wherein:

FIG. 1 shows a conventional computer, mouse and controller;

FIG. 2 shows a perspective view of a mouse and a controller applied to a computer system according to the present invention;

FIG. 3 shows a perspective view of the mouse and controller before being installed in the mouse;

FIG. 4 shows the assembly of the mouse and the controller;

FIG. 5 shows the open status of a receiving chamber of the mouse;

FIG. 6 shows the closed status of the receiving chamber;

FIG. 7 shows a second embodiment of the mouse;

FIG. 8 shows a third embodiment of the mouse; and

FIG. 9 shows a fourth embodiment of the mouse.

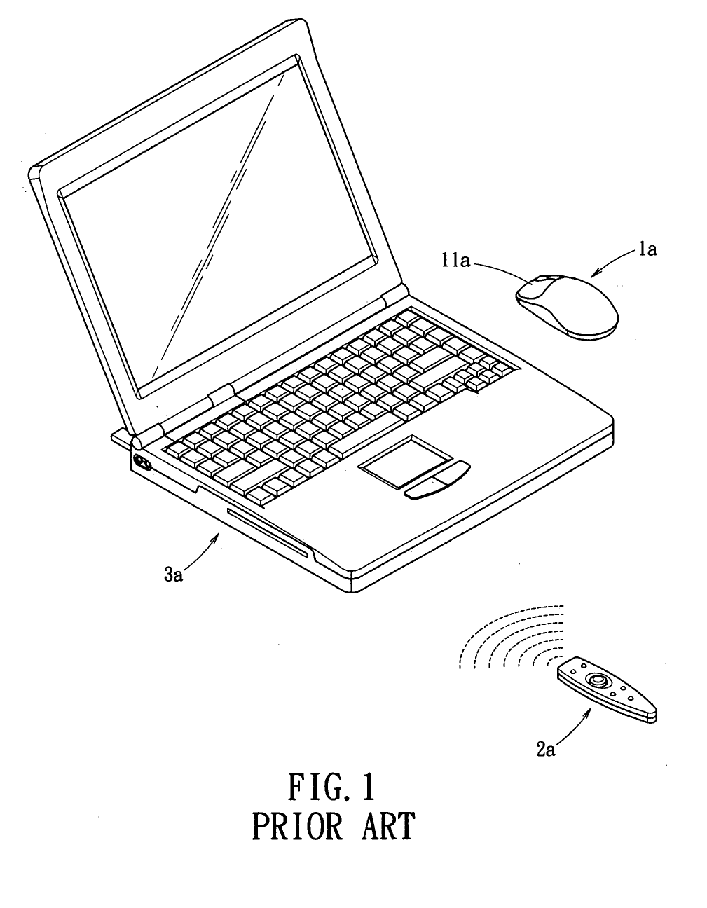

### DETAILED DESCRIPTION OF THE INVENTION

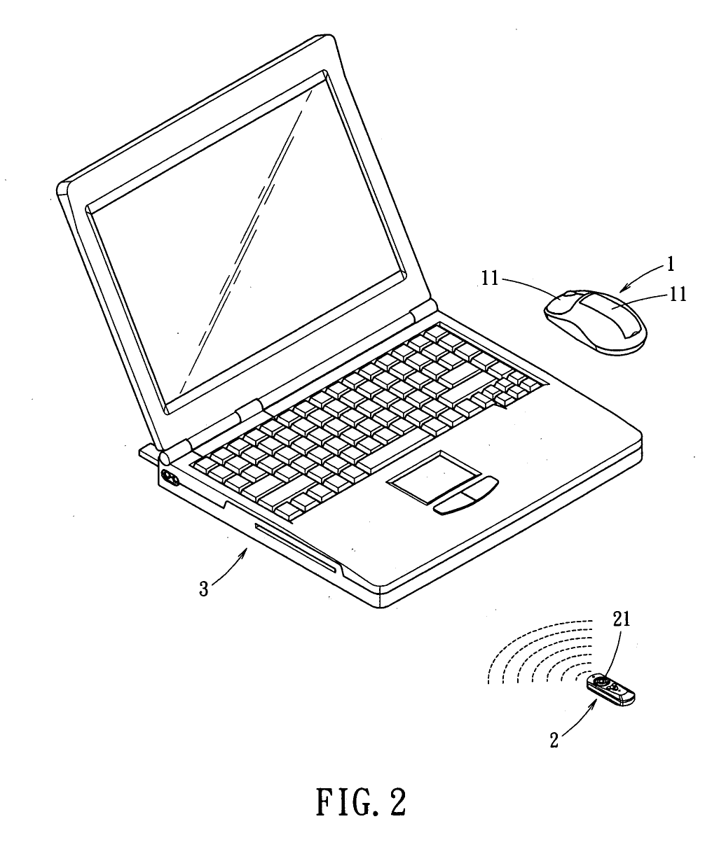

The present invention provides an improved mouse structure. As shown in FIG. 2, a wireless optical mouse 1 includes a front portion having a set of buttons 11 formed thereon, a rear portion, a top surface (the hand-held portion) and a bottom surface. It is appreciated that the present invention can also be applied other type of mouse. In this embodiment, an unused space of the mouse 1 is used as a space for storing a controller 2 therein.

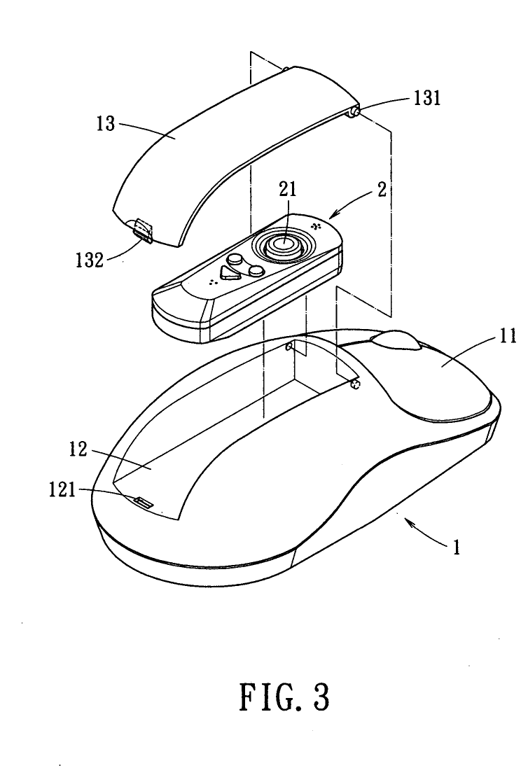

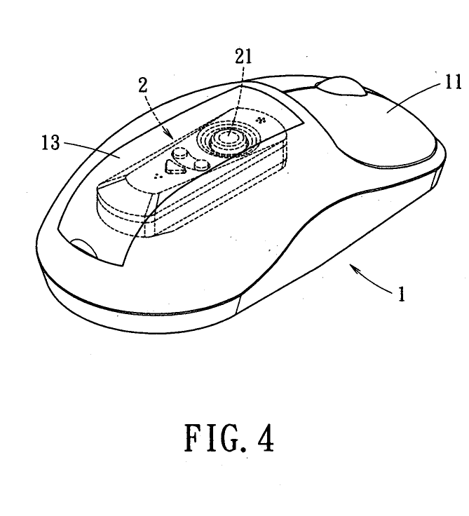

Referring to FIGS. 3 and 4, a schematic drawing of a mouse is illustrated. The mouse 1 includes a set of buttons 11 in the front portion and an optical device or roller at the bottom surface. Therefore, only the hand-held top surface does not include any device formed therein. Therefore, the hand-held top surface can be converted into a receiving chamber 12. In this embodiment, the size of the receiving chamber 12 is suitable for disposing a controller 2. On top of the receiving chamber 12 an openable lid 13 is formed. Preferably, the lid 13 is configured with a contour conformal to the hand of the user. A front side of the lid 13 includes a pair of pivots 131 for pivotally connecting to the front portion of the mouse 1, while the rear side of the lid 13 includes a snapping structure 132 to snap with a snap hole 121 formed at a rear edge of the receiving chamber 12.

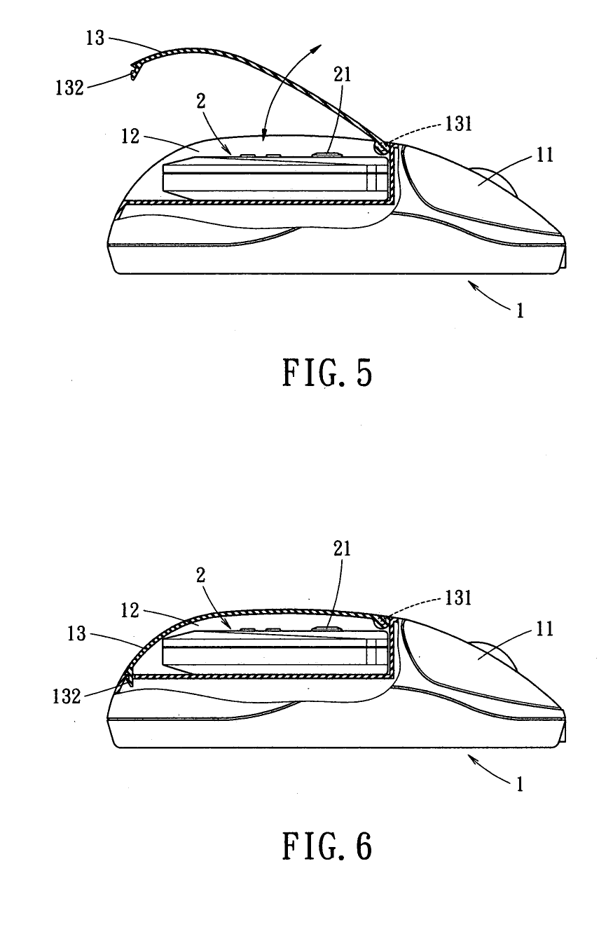

As shown in FIG. 5, the controller 2 or other article can be disposed in the receiving chamber 12. In application, the rear side of the lid 13 is lifted to open the receiving chamber 12, such that the controller 2 can be removed from the receiving chamber. After application, the lid 13 is open again allowing the controller 2 to be stored in the receiving chamber 12. By engaging the snapping structure 132 and the snap hole 121, the controller 2 can be secured in the receiving chamber 12 as shown in FIG. 6.

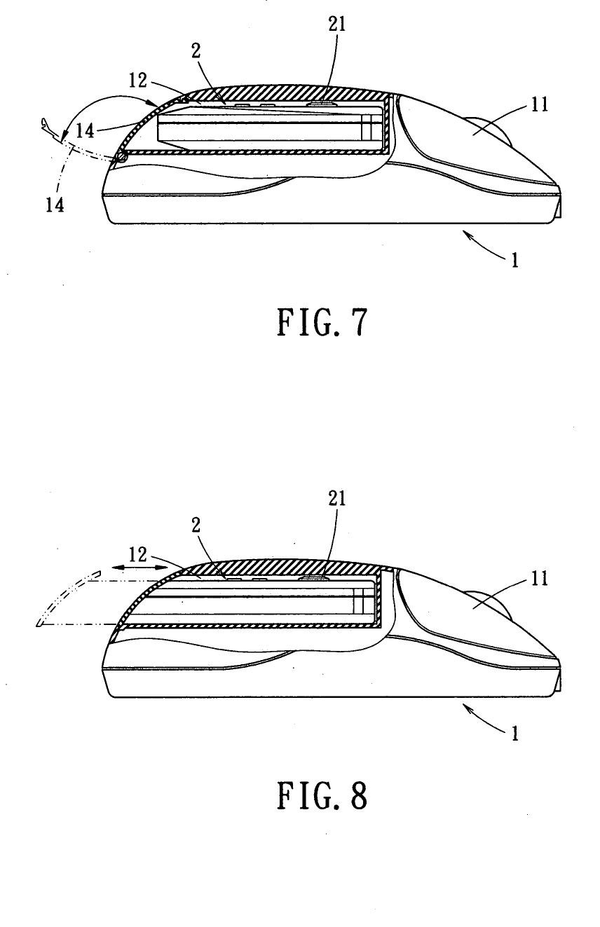

FIG. 7 shows a second embodiment of the present invention. As shown, a rear portion of the mouse 1 is hollow, and an opening is formed at the rear end of the mouse 1. Therefore, the controller 2 can be inserted into the mouse 1 through the opening. The opening may be closed by a lid 14. One side of the lid 14 is pivotally connected to the rear end of the mouse 1, allowing the other side of the lid 14 to flip open or close. FIG. 8 shows another embodiment of the present invention. As shown, no lid is installed for the receiving chamber 12, while the controller 2 can still be safely retained therein.

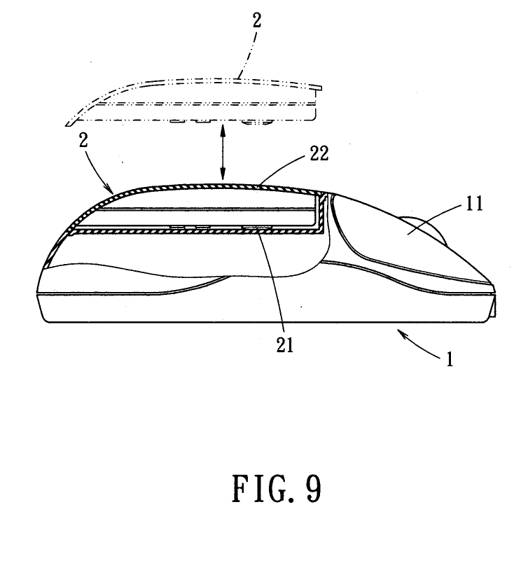

FIG. 9 shows yet another embodiment of the mouse. As shown, the rear portion of the mouse 1 is recessed to form a platform on which the controller 2 can be disposed. The controller 2 includes a control surface 21 and a hand-held surface 22 opposing to the control surface 21. When the controller 2 is disposed on the platform, the control surface 21 is facing downward, while the hand-held surface 22 serves as the hand-held surface of the user. When the controller 2 is removed from the mouse, an enclosure may be used to fit over the platform and serve as the hand-held surface.

From the above description, the present invention provides a mouse 1 in which a receiving chamber 12 is formed, allowing the controller 2 or other peripheral or article of the computer to be stored in the mouse 1.

This disclosure provides exemplary embodiments of the present invention. The scope of this disclosure is not limited by these exemplary embodiments. Numerous variations, whether explicitly provided for by the specification or implied by the specification, such as variations in shape, structure, dimension, type of material or manufacturing process may be implemented by one of skill in the art in view of this disclosure.

1. An improved mouse structure, characterized in forming a receiving chamber inside of a mouse for storing an external article.

2. The mouse structure according to claim 1, wherein the receiving chamber is formed at an upper part of a rear portion of the mouse.

3. The mouse structure according to claim 1, wherein the mouse includes an open top surface for the article to be disposed in or removed from the receiving chamber.

4. The mouse structure according to claim 3, wherein the open top surface includes a lid, the lid has one end pivotally connected to one side of the receiving chamber, and the other end with a snapping structure to be engaged with the other side of the receiving chamber.

5. The mouse structure according to claim 1, wherein the mouse includes an open rear surface, allowing the article to be disposed in or removed from the mouse.

6. The mouse structure according to claim 5, wherein the mouse includes a lid to close or open the receiving chamber.

7. The mouse structure according to claim 1, wherein the mouse includes a recessed rear portion serving as the receiving chamber when the article disposed in the receiving chamber includes a hand-held surface in contact with the hand of a user.

8. The mouse structure according to claim 1, wherein the article includes a controller.
